(19) United States
(12) Patent Application Publication
(10) Pub. No.: US 2019/0024593 A1
(43) Pub. Date: Jan. 24, 2019

(54) Valve Train and Engine Assembly

(71) Applicant: Bayerische Motoren Werke Aktiengesellschaft, Muenchen (DE)

(72) Inventors: Martin SCHENK, Rosenheim (DE); Michael SALLMANN, Muenchen (DE); Din WABBALS, Muenchen (DE)

(21) Appl. No.: 16/143,661

(22) Filed: Sep. 27, 2018

Related U.S. Application Data
(63) Continuation of application No. PCT/EP2017/056763, filed on Mar. 22, 2017.

(30) Foreign Application Priority Data
Apr. 7, 2016 (DE) 10 2016 205 805.3

(51) Int. Cl. F02D 13/02; F01L 1/047; F01L 1/344

(52) U.S. Cl. CPC F02D 13/0207; F02D 13/0257; F01L 1/34403; F01L 1/047

(57) ABSTRACT

A valve train for an engine of a motor vehicle and an engine assembly with such a valve train is provided. The valve train includes at least two inlet and/or outlet valves, and at least two motorized actuating units configured to independently control the maximum valve lifts of respective ones of the valves. A first actuating unit of the at least two actuating units is associated with a first valve of the at least two valves, and a second actuating unit is associated with a second valve of the at least two valves.

### CROSS REFERENCE TO RELATED APPLICATIONS

This application is a continuation of PCT International Application No. PCT/EP2017/056763, filed Mar. 22, 2017, which claims priority under 35 U.S.C. § 119 from German Patent Application No. 10 2016 205 805.3, filed Apr. 7, 2016, the entire disclosures of which are herein expressly incorporated by reference.

### BACKGROUND AND SUMMARY OF THE INVENTION

The invention relates to a valve train for an engine of a motor vehicle and an engine subassembly.

There are known from the prior art valve trains for an engine of a motor vehicle, in which a maximum valve stroke of at least two valves of a cylinder of a common motorized adjustment unit which has an adjustment shaft having at least one adjustment cam is adjusted. The valves are typically inlet valves. The valve stroke lines of the two valves have, as a result of the common adjustment unit, a fixed relative coupling so that a valve stroke value of the first valve corresponds to a predefined valve stroke value of the second valve. As a result of the fixed coupling, a compromise which is necessary for all operating locations has to be carried out.

It is known from the prior art to optimize the control of the valves in such a manner that an improved charge movement occurs and at the same time the charge changes losses are reduced. This is generally achieved by means of a coupled and mechanical valve stroke variability. Inter alia, to this end, a fixed mechanical offset of the coupled valve strokes is provided, which results in an at least partially different stroke behavior of the valves. This is also referred to as “phasing”. Typically, the “phasing” is achieved by means of special contours of the adjustment cam. The result of the “phasing” is shown in the graph of FIG. 7. As a result of the more significant valve stroke of one of the valves, at least temporarily an increased directed air mass flow is achieved via this valve, whereby a twisting movement of the air mass flow is produced inside the cylinder.

It is further known from the prior art that a masking at the valve seats of the valves is provided in order to produce a selectively directed charge movement. This masking is typically carried out via a single-sided gap which is produced as a result of a specific contour in the region of the valve seats when the valve opens. Such a masking is schematically illustrated in FIG. 8. The masking produces a twisting and/or tumble movement of the mass flow.

Generally, the valve strokes of the valves accordingly cannot be freely selected and are dependent on each other.

It has been found to be disadvantageous in this instance that, as a result of the fixed coupling of the valve strokes of the valves, no individual control of the valves which is optimized in terms of speed and/or operating location can be carried out. The uniquely defined coupling of the two valve strokes thus cannot be changed and is valid for all operating states, in particular full-load ranges and idle ranges. Narrow limits are thereby set for the control of the valves in order to achieve optimum combustion in the cylinder.

Alternatively, there are known from the prior art valve trains and engine subassemblies which do not have any valve stroke variability. The quantity of air supplied to the cylinder is controlled only via a throttling. In this instance, however, there are greater charge change losses than with the valve trains with valve stroke variability known from the prior art. This can be seen from the graph of FIG. 9.

An object of the invention is to provide a valve train and an engine subassembly, by means of which an optimum combustion with low charge change losses can be achieved.

The object is achieved according to the invention by a valve train for an engine of a motor vehicle having at least two valves which are constructed as inlet valves or as outlet valves and at least two motorized adjustment units which are independent of each other, wherein a first adjustment unit of the at least two adjustment units is associated with a first valve of the at least two valves and a second adjustment unit of the at least two adjustment units is associated with a second valve of the at least two valves, and wherein the adjustment units adjust the maximum valve strokes of the valves independently of each other in each case.

The basic notion of the invention is to decouple the valve strokes of the at least two valves from each other so that the cycle-specific maximum strokes of the at least two valves can be adjusted independently of each other. The valves can thereby be controlled in operating location specific terms so that the charge movements of the valves can be optimized. The compromise required in the prior art in terms of the operating locations during the coupling of the inlet valves of a cylinder is superfluous.

One aspect makes provision for the adjustment units to adjust the maximum valve stroke of the associated valve in a stepless and very precise manner in order to achieve an optimum combustion in the engine.

In particular, the adjustment units each comprise a motorized adjustment drive and at least one adjustment mechanism which changes the position of the associated valve, in particular the position of a valve element of the valve with respect to the valve seat thereof. Via the mechanical construction, a simply constructed possibility which is insensitive to disruptions is provided in order to adjust the maximum valve strokes of the valves.

In particular, the adjustment mechanism has at least one adjustment shaft having at least one adjustment cam which is rotated by means of the adjustment drive. Via the adjustment shaft and the adjustment cam, a rotational movement can be converted in a simple manner into a translational movement for displacing an intermediate lever. Via the shape of the adjustment cam, a change of the travel path can additionally be achieved. The adjustment shaft may be an eccentric shaft which accordingly has an eccentric as an adjustment cam.

Furthermore, the adjustment cam may engage on an intermediate lever which drives a roller cam follower whose rotation location is displaced by moving the adjustment cam. The displacement of the roller cam follower in the region of the pivot bearing thereof ensures in a simple manner that the maximum valve stroke of the associated valve is changed. By adjusting the adjustment cam, the region of the intermediate lever which engages on the roller cam follower is changed so that the maximum valve stroke is adjusted.

According to one aspect, an adjustment unit adjusts the maximum valve stroke of a plurality of valves, in particular the maximum valve stroke of one valve per cylinder of the engine. Accordingly, for example, a single adjustment unit adjusts the maximum valve strokes of all the first inlet valves of all the cylinders of the engine.

Alternatively, the first inlet valves of all the cylinders are associated in groups with an adjustment unit so that the adjustment unit adjusts, for example, the maximum valve stroke of the first and the third cylinder of a four-cylinder engine.

In another alternative, a single-valve control is present so that each individual valve in the engine has an adjustment unit which is associated therewith and which adjusts the maximum valve stroke of the valve.

In a similar manner, the maximum valve strokes of the outlet valves can be adjusted in such a manner in order, for example, to optimize an exhaust gas return by means of which an additional charge movement can also be generated.

Furthermore, there may be provided at least one control time adjustment unit which adjusts the control times of the valves independently of each other. It is thereby possible to achieve a variation which is individual to the operating location in respect of the respective opening time and/or opening duration of the valves. The control of the valves then comprises an additional degree of freedom in order to achieve optimum combustion in the engine. The control time adjustment unit accordingly defines inter alia the phase position of the maximum valve stroke.

In particular, there is provided at least one camshaft with which the at least one control time adjustment unit cooperates, wherein the control time adjustment unit adjusts the relative position of the camshaft, in particular relative to a crankshaft of the engine. The valves are thereby coupled in a simple manner to the camshaft so as to be able to be modified, whereby the respective control times of the valves can be adjusted, that is to say, the phase position thereof.

One aspect makes provision for the control time adjustment unit to comprise at least one adjustment drive with variable camshaft overlap. Such an adjustment drive is, for example, a VANOS adjustment drive. The adjustment drive may be arranged between the camshaft and a chain drive, wherein it adjusts the relative angular position of the camshaft relative to the crankshaft in accordance with the operating location and peripheral environmental conditions.

According to an embodiment, there are provided two camshafts and two control time adjustment units which are independent of each other, each having an adjustment drive for variable camshaft overlap, wherein a first control time adjustment unit and a first camshaft are associated with the first valve and a second control time adjustment unit and a second camshaft are associated with the second valve, in particular wherein the control time adjustment units are each associated with one of the two adjustment units. The control times of the at least two valves can thereby be controlled individually and separately from each other. The adaptation of the valve strokes which is individual to the operating location can thereby be adjusted more freely, in particular with regard to the opening times.

Generally, the aspects of an individual valve train relate to a valve train which is provided at the inlet side or at the outlet side.

According to another aspect, the camshaft has at least one in particular stepped control cam. A stepped switching solution which in particular enables an individual valve control can accordingly be implemented.

The adjustment units and the control time adjustment units may in particular be controlled relative to each other, wherein the control is carried out in a decoupled or coupled manner.

Furthermore, the object is achieved with an engine subassembly according to the invention having an engine, at least one cylinder and at least one valve train according to the invention. The above-mentioned advantages with respect to the valve train are produced in a similar manner in the engine subassembly.

One aspect makes provision for the engine subassembly to have a plurality of cylinders which each have at least two inlet and/or two outlet valves, wherein each cylinder has a first inlet and/or first outlet valve and a second inlet and/or second outlet valve, and wherein all the first inlet or outlet valves are each associated with a first adjustment unit of the at least two adjustment units and all the second inlet and outlet valves are associated with a second adjustment unit of the at least two adjustment units so that the at least two adjustment units adjust the maximum valve strokes of the inlet and/or outlet valves of all the cylinders. An engine subassembly is consequently provided by means of which the respective inlet valves and outlet valves of the cylinders are decoupled from each other. The inlet valves and outlet valves and the maximum stroke paths thereof can therefore be controlled or adjusted independently of each other. There is thereby produced, as already mentioned, a high level of flexibility with regard to the control of the valves, which results in an optimized charge movement or a valve control with a high degree of freedom.

According to an embodiment, there are provided a plurality of cylinders which each have at least two inlet and/or two outlet valves, wherein each cylinder has a first inlet and/or a first outlet valve and a second inlet and/or a second outlet valve, and wherein the first inlet valves or outlet valves of the cylinders are divided into at least two groups and an individual valve train is associated with each group. For example, a paired control can be produced in this manner. Generally, a more individual adjustment of the valve strokes is possible since this occurs in groups.

The degree of individualization can be further increased if an individual valve train is associated with each inlet valve and/or each outlet valve of a cylinder. An individual cylinder adjustment is even thereby possible.

According to an embodiment, in particular two valve trains of the above-mentioned type may be provided, wherein the first valve train is an inlet valve train which has inlet valves and the second valve train is an outlet valve train which has outlet valves. Accordingly, both the inlet valves and the outlet valves can be controlled independently of each other in a cylinder, in particular the control times thereof and the maximum valve strokes thereof.

Another aspect makes provision for a control unit which controls at least the adjustment units. The control unit may involve the control of the valves or a charge movement control by means of which an optimal combustion in the engine is intended to be achieved. The control unit uses, for example, vehicle-specific data in order to establish the current operating location of the motor vehicle. Depending on the operating location, the control unit then controls the adjustment units and/or the control time adjustment units in order to adjust the maximum valve strokes and control times of the associated valves in a manner specific to the operating location.

The at least one cylinder has in particular a cylinder head which has a contour so that a one-sided gap is produced in the region of at least one valve seat of one of the valves when the valve is opened. A valve masking which constitutes a predefined support for the optimization of the charge movement of the valves is thereby produced.

Furthermore, a “phasing” may be provided, that is to say, a fixed offset of the valve strokes of the inlet or outlet valves which is associated with a cylinder. A structure-related optimization of the charge movement is thereby also produced.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of a valve train in accordance with an embodiment of the present invention.

FIG. 2 shows a portion of the valve train from FIG. 1 with a minimum valve stroke of the valve.

FIG. 3 shows the valve train from FIG. 2 with a maximum valve stroke of the valve.

FIG. 4 is a graph to explain the adjustments of the maximum valve stroke. in accordance with an embodiment of the present invention

FIG. 5 is a graph to explain the displacement of the control times and the valve stroke.

FIG. 6 is a schematic illustration of an engine subassembly in accordance with an embodiment of the present invention.

FIG. 7 is a graph to explain the phasing in the prior art.

FIG. 8 is a schematic illustration of the valve masking.

FIG. 9 is a graph with two charge lines of two valve trains known from the prior art.

### DETAILED DESCRIPTION OF THE DRAWINGS

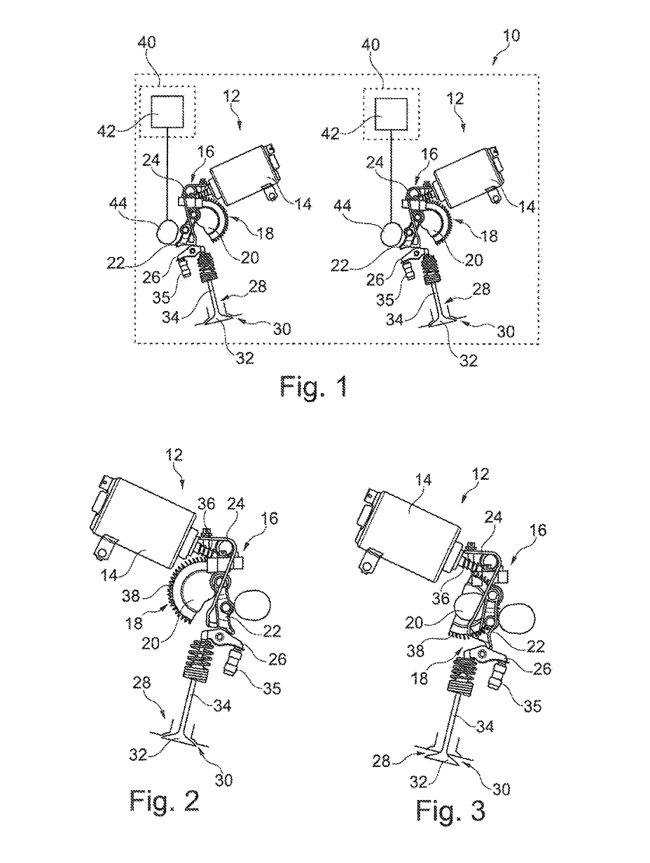

FIG. 1 shows a valve train 10 for an engine of a motor vehicle and the valves thereof. In the embodiment shown, the valve train 10 comprises two motorized adjustment units 12 which are not coupled to each other.

Each of the adjustment units 12 has an individual electromotive adjustment drive 14 and an adjustment mechanism 16 which comprises an adjustment shaft 18 with an adjustment cam 20 which is fitted thereto and an intermediate lever 22 which engages at the outer side on the adjustment cam 20. The intermediate lever 22 is pretensioned by a restoring spring 24 counter to a camshaft 44. The intermediate lever 22 is driven by the camshaft 44.

The adjustment shaft 18 may be a camshaft so that the at least one adjustment cam 20 is an eccentric.

The intermediate lever 22 additionally drives a roller cam follower 26 which activates a valve 28 which has a valve seat 30 and a valve element 32. The valve element 32 is coupled to the roller cam follower 26 by a valve tappet 34. The valve element 32 and the valve tappet 34 may be constructed integrally together. In addition, they are also referred to as a valve disk and valve shaft. A hydraulic valve play compensation element is designated 35.

The two valves 28, which are each associated with one of the two adjustment units 12, are two inlet valves of a common cylinder. The valves 28 are generally arranged one behind the other in the view shown, but for greater clarity are illustrated beside each other in this instance.

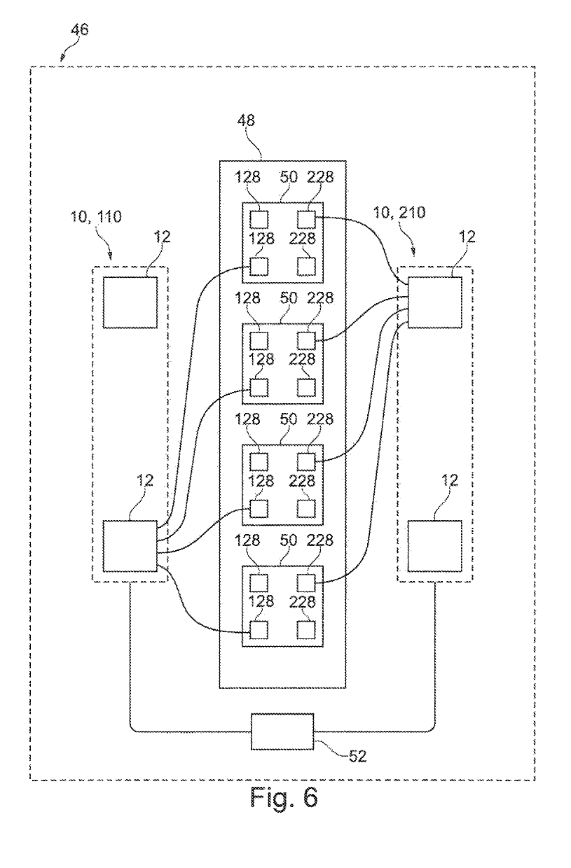

Furthermore, the valves 28 are each part of a valve subassembly, wherein the first valve subassembly comprises in each case the first valves of each cylinder of the engine and the second valve subassembly comprises in each case the second valves of each cylinder of the engine (see also FIG. 6 and associated description).

Alternatively, the two valves 28 shown may be outlet valves of the common cylinder of the engine.

FIGS. 2 and 3 show how one of the two adjustment units 12 via the adjustment mechanism 16 and the adjustment drive 14 adjusts the maximum valve stroke of the associated valve 28 in each case. The principle can be transferred in a similar manner to the other adjustment unit 12.

The adjustment drive 14 has a worm shaft 26 which meshes with a worm wheel 38 which is coupled to the adjustment shaft 18 so that the adjustment shaft 18 is thereby driven in rotation. The worm wheel 38 is also part of the adjustment mechanism 16.

As a result of the actuated adjustment drive 14, the adjustment shaft 18 and the adjustment cam 20 which is arranged thereon is moved from the position shown in FIG. 2, in which the valve stroke is minimal (minimum stroke position), into the position with a maximum valve stroke (maximum stroke position) which is shown in FIG. 3.

When moved into the maximum stroke position, the adjustment cam 20 moves the intermediate lever 22, whereby the rotation location thereof is displaced. As a result of the displacement of the intermediate lever 22, it engages with other portions on the roller cam follower 26 which moves the valve element 32 via the valve tappet 34 in translation, in particular moves it away from the valve seat 30. The valve 28 consequently has in the position shown in FIG. 3 a larger maximum valve stroke when adjusted by the following cam drive than in the minimum stroke position shown in FIG. 2.

In the embodiment shown, per valve subassembly there is provided a respective control time adjustment unit 40 which comprises an adjustment drive 42 which in each case cooperates with a camshaft 44. The adjustment drive 42 is in particular an adjustment drive with which a variable camshaft overlap is possible so that a modification of the coupling of the camshaft 44 can be carried out by a camshaft which is not shown in this instance. Other control times of the associated valve 28 can thereby be adjusted.

The respective camshaft 44 engages, when it has been adjusted by the corresponding control time adjustment unit 40, in a modified manner on the intermediate lever 22 since the coupling with the camshaft is modified.

Furthermore, there may be provision for the camshaft 44 to have at least one stepped control cam via which a stepped switching solution can be implemented. With this alternative, it is also possible to form an individual valve control.

For example, the position shown in FIG. 2 may be used when the engine is in idle mode, wherein the maximum valve stroke is between 0.1 mm and 1 mm. In contrast, the position shown in FIG. 3 may be provided at full load, wherein the maximum valve stroke is between 5 mm and 15 mm, in particular 10 mm.

Generally, it is shown in FIG. 1 that the two valves 28 each have an individual adjustment unit 12 and an individual control time adjustment unit 40 so that the maximum valve stroke of the two valves 28 and the control times thereof can be adjusted independently of each other.

Alternatively, it is possible that the adjustment unit 12 which is associated with a valve 28 is coupled to the corresponding control time adjustment unit 40 so that the adjustment of the corresponding valve 28 is carried out in a coupled manner.

As already explained, the valves 28 shown in FIGS. 1 to 3 are inlet or outlet valves of a common cylinder which are each part of a valve subassembly.

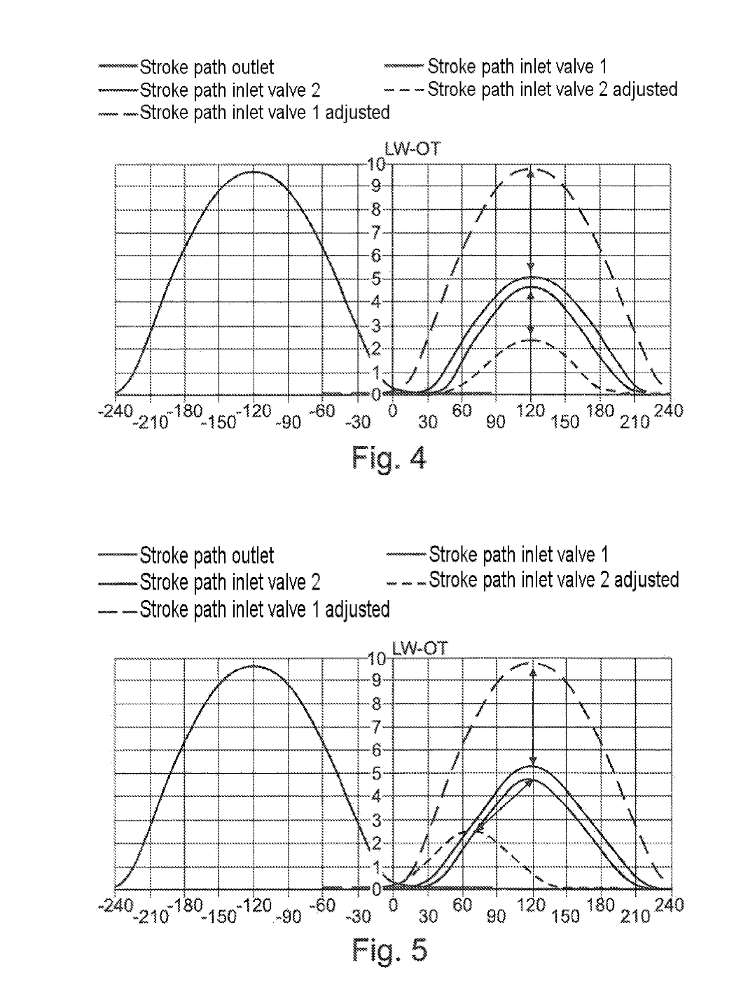

FIGS. 4 and 5 show how the stroke lines of two inlet valves 28 can be changed when the respective adjustment unit 12 and/or the respective control time adjustment unit 40 is/are activated. The stroke line of a valve 28 refers to the stroke which the valve element 32 carries out with the valve tappet 34 arranged thereon with respect to the associated valve seat 30. For the sake of clarity, the valve stroke of the valve 28 is referred to.

FIG. 4 shows that the adjustment unit 12 associated with a first inlet valve 28 has increased the maximum valve stroke of the first inlet valve 28, whereas the adjustment unit 12 associated with a second inlet valve 28 has reduced the maximum valve stroke thereof. The stroke lines of the two inlet valves 28 changed by the adjustment units 12 are each shown with broken lines with respect to the unchanged stroke lines, which are illustrated with solid lines. It is thereby possible to carry out an operating-location-specific adjustment of the two inlet valves 28, whereby an optimum combustion in the engine is possible. The stroke of the outlet illustrated on the left is provided only for information.

FIG. 5 shows an expansion of FIG. 4 in which additionally the control time adjustment unit 40 associated with the second inlet valve 28 has been activated. A changed control time of the second inlet valve 28 is thereby produced. The comparison of FIGS. 4 and 5 shows that the second inlet valve 28 has been controlled earlier than in FIG. 4.

Via the control time adjustment unit 40, an additional degree of freedom for the operating-location-specific control of the valves 28 is generally produced.

The corresponding changes of the stroke lines of the inlet valves can be used in a similar manner on the outlet valves.

FIG. 6 shows an engine subassembly 46 which has an engine 48 which in the embodiment shown has four cylinders 50. Each of the four cylinders 50 has four valves 28, of which two valves 128 are inlet valves and two valves 228 are outlet valves, respectively.

The engine subassembly 46 further comprises two valve trains 10 which each have two adjustment units 12.

For better distinction, the valves 28 and valve trains 10 and the components thereof are provided below with specific reference numerals in order to enable a better distinction between the inlet side and the outlet side of the engine subassembly 46.

The first valve train 10 is, for example, an inlet valve train 110 which cooperates via the two adjustment units 12 with the inlet valves 128 of the respective four cylinders 50. The second valve train 10 is then an outlet valve train 210 which cooperates with the respective outlet valves 228 of the four cylinders 50.

Furthermore, the engine subassembly 46 comprises a control unit 52 which is coupled to the two valve trains 10 in order to control them, in particular the corresponding adjustment units 12. The control unit 52 may further be coupled to additional sensors of the motor vehicle in order in particular to obtain information relating to the current operating state of the motor vehicle.

In the embodiment of the engine subassembly 46 shown, the maximum travel paths of all the first inlet valves 128 are adjusted by the first of the two adjustment units 12 of the first valve train 110, whereas the maximum stroke paths of the second inlet valves 128 of the respective cylinders 50 are adjusted by the second of the two adjustment units 12 of the first valve train 110. This can be seen from the corresponding lines in FIG. 6, wherein, for reasons of clarity, only the connections of the first inlet valves 128 to the first adjustment unit 12 of the inlet valve train 110 are illustrated.

In a similar manner, the adjustment of the maximum valve strokes of the outlet valves 228 is carried out by the two adjustment units 12 of the second valve train 210, wherein in this instance only the connections of the second outlet valves 228 of each cylinder 50 to the second of the two adjustment units 12 of the outlet valve train 210 are illustrated.

The valve trains 10 may further each have control time adjustment units 40 which for reasons of clarity are also not illustrated in FIG. 6. The above-described properties relating to the valve train 10 according to FIGS. 1 to 3 and the graphs of FIGS. 4 and 5 can be transferred in a similar manner to the engine subassembly 46.

Alternatively, the first inlet valves 128 of the four cylinders 50 may each be associated in pairs with an adjustment unit 12 of a first inlet valve train 110 so that a total of two inlet valve trains 110 would be provided. The adjustment of the maximum valve strokes of the inlet valves 128 can thereby be adjusted in pairs and consequently in an even more individual manner. In the specific example of the engine subassembly 46 shown with four cylinders 50, this means that the first inlet valves 128 of the first and third cylinder 50 are associated with an adjustment unit 12 of a first inlet valve train 110, whereas the first inlet valves 128 of the second and fourth cylinder 50 are associated with an adjustment unit 12 of a second inlet valve train 110, respectively. This applies in a similar manner to the second inlet valves 128 of the cylinders 50.

In another alternative, each individual inlet valve 128 of the cylinders 50 is associated with an individual adjustment unit 12, whereby an individual cylinder adjustment of the respective inlet valves 128 is produced.

These alternative embodiments can be transferred in a similar manner to the outlet valves 228.

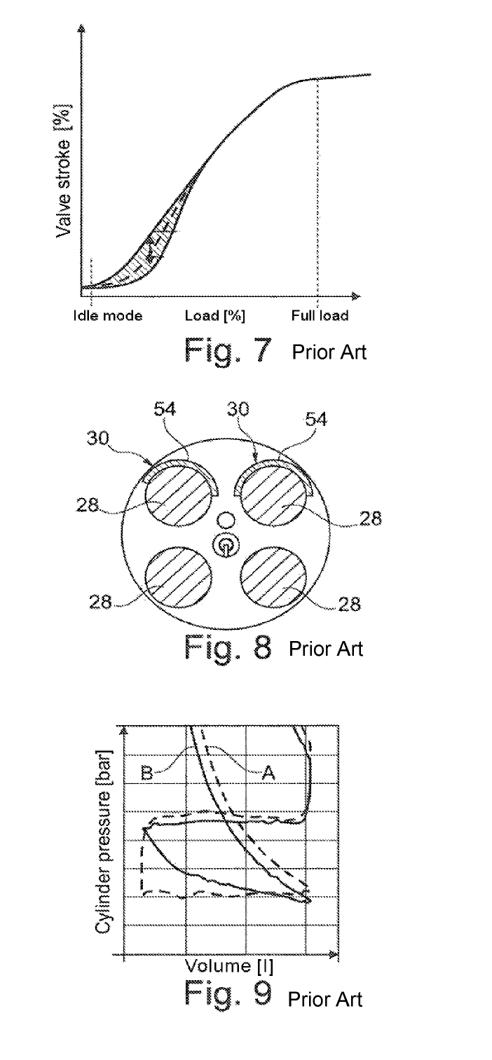

In FIGS. 7 and 8, measures known from the prior art for pre-defined optimization of the charge movement are illustrated. FIG. 7 is a graph relating to the so-called “phasing” mentioned in the introduction, in which a structure-related and fixed relative offset of the valve stroke lines of two valves 28 is provided.

FIG. 8 shows a masking of two valves 28 via which the orientation of the mass flow can be adjusted. In this instance, the corresponding valve seat 30 has a contour 54 via which there is produced when the corresponding valve 28 is opened a predefined gap which has an influence on the inlet ratios at the valves 28.

Both the “phasing” and the masking may be provided with the valve trains 10 in order to provide structure-related optimization additionally or alternatively. This is particularly advantageous if a compromise is intended to be achieved between structure-related optimization and optimization in terms of technical control of the inlet ratios at the valves 28.

FIG. 9 shows a graph of two charge change loops which are achieved with valve trains A, B known from the prior art. The charge change line (pressure/volume (PV) line A is a PV line of a valve train known from the prior art without valve stroke variability, whereas the charge change line B shows a charge change line of a valve train known from the prior art with valve stroke variability.

From the two charge change lines A, B, it can be seen that the charge change line of the valve train without valve stroke variability has higher charge change losses.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A valve train for an engine, comprising:
at least two valves, the at least two valves being at least one of inlet valves and outlet valves;
at least two motorized adjustment units which are independent of each other,
wherein
a first adjustment unit of the at least two motorized adjustment units is associated with a first valve of the at least two valves and a second adjustment unit of the at least two adjustment units is associated with a second valve of the at least two valves, and
the first and second adjustment units are configured to adjust maximum valve strokes of the first and second valves independently of each other.

2. The valve train as claimed in claim 1, wherein
the first and second adjustment units are configured to adjust the maximum valve stroke of the respective first and second valves in a stepless manner.

3. The valve train as claimed in claim 2, wherein
the first and second adjustment units each include a motorized adjustment drive and at least one adjustment mechanism configured to change a position of the respective first and second valves with respect to respective valve seats.

4. The valve train as claimed in claim 3, wherein
the first and second adjustment mechanisms each include at least one adjustment shaft having at least one adjustment cam rotatable by the adjustment drive.

5. The valve train as claimed in claim 4, wherein
each of the at least one adjustment cams is configured to engage a respective intermediate lever arranged to drive a respective roller cam follower, and
a rotation location of each respective intermediate lever moves when the respective adjustment cam is rotated.

6. The valve train as claimed in claim 5, wherein
the at least two valves includes a plurality of valves, and
at least one of at least two motorized adjustment units is configured such that when actuated the maximum valve stroke of a subset of the plurality of valves is adjusted by the at least one of at least two motorized adjustment units.

7. The valve train as claimed in claim 6, wherein
the subset of the plurality of valves include at least one valve of each cylinder of the engine.

8. The valve train as claimed in claim 1, further comprising:
at least one control time adjustment unit configured to adjust control times of the at least two valves independently of each other.

9. The valve train as claimed in claim 8, further comprising:
at least one camshaft configured to cooperate with the at least one control time adjustment unit to adjust a position of the camshaft relative to a crankshaft of the engine.

10. The valve train as claimed in claim 8, wherein
the control time adjustment unit is configured to control at least one camshaft position adjustment drive to provide variable camshaft overlap.

11. The valve train as claimed in claim 10, wherein
the at least one camshaft includes two camshafts,
the at least one control time adjustment unit includes two control time adjustment units which are independent of each other, each having a respective one of the at least one camshaft position adjustment drive for variable camshaft overlap, and
a first one of the two control time adjustment units and a first one of the two camshafts are associated with a first one of the at least two valves and a second one of the two control time adjustment units and a second one of the two camshafts are associated with a second one of the at least two valves.

12. The valve train as claimed in claim 11, wherein
each of the two camshafts has at least one stepped control cam.

13. An engine subassembly, comprising:
an engine having at least one cylinder and at least one valve train, each of the at least one valve train including
at least two valves, the at least two valves being at least one of inlet valves and outlet valves;
at least two motorized adjustment units which are independent of each other,
wherein
a first adjustment unit of the at least two motorized adjustment units is associated with a first valve of the at least two valves and a second adjustment unit of the at least two adjustment units is associated with a second valve of the at least two valves, and
the first and second adjustment units are configured to adjust maximum valve strokes of the first and second valves independently of each other.

14. The engine subassembly as claimed in claim 13, wherein
the at least one cylinder includes a plurality of cylinders,
the at least two valves include, in each of the plurality of cylinders, at least one of at least two inlet and at least two outlet valves,
if at least two inlet valves are present in each of the plurality of cylinders, the at least two inlet valves include a first inlet valve and a second inlet valve,
if at least two outlet valves are present in each of the plurality of cylinders, the at least two outlet valves include a first outlet valve and a second outlet valve,
all of the first inlet and first outlet valves present are each associated with the first adjustment unit,
all of the second inlet and second outlet valves present are each associated with the second adjustment unit, and
the first and second adjustment units adjust the maximum valve strokes of the present first and second inlet and/or outlet valves in all the cylinders.

15. The engine subassembly as claimed in claim 13, wherein
the at least one cylinder includes a plurality of cylinders,
the at least two valves include, in each of the plurality of cylinders, at least one of at least two inlet and at least two outlet valves,
if at least two inlet valves are present in each of the plurality of cylinders, the at least two inlet valves include a first inlet valve and a second inlet valve,
if at least two outlet valves are present in each of the plurality of cylinders, the at least two outlet valves include a first outlet valve and a second outlet valve,
the at least one valve train includes at least two valve trains,
the present first and second inlet and/or outlet valves are divided into at least two groups, and
each of the at least two groups is associated with a respective one of the at least two valve trains.

16. The engine subassembly as claimed in claim 15, wherein
a first one of the at least two valve trains is an inlet valve train and a second one of the at least two valve trains is an outlet valve train.

17. The engine subassembly as claimed in one of claim 13, further comprising:
a control unit configured to control actuation of the at least two motorized adjustment units.
